(19) United States
(12) Patent Application Publication
(10) Pub. No.: US 2026/0141052 A1
(43) Pub. Date: May 21, 2026

(54) MALICIOUS SCRIPT DETECTION USING TRANSFORMER-BASED DEEP LEARNING

(71) Applicant: Palo Alto Networks, Inc., Santa Clara, CA (US)

(72) Inventors: Feng Xiao, San Jose, CA (US); Yang Ji, San Jose, CA (US); Wenjun Hu, Santa Clara, CA (US)

(21) Appl. No.: 18/949,606

(22) Filed: Nov. 15, 2024

(51) Int. Cl. G06F 21/53; G06F 21/56

(52) U.S. Cl. CPC G06F 21/53; G06F 21/566; G06F 2221/033

(57) ABSTRACT

Techniques for providing malicious script detection using transformer-based deep learning are disclosed. In some embodiments, a system/process/computer program product for providing malicious script detection using transformer-based deep learning includes receiving a sample for automated malicious script detection using a computing environment; processing the sample using a transformer model to generate a plurality of embeddings; processing the plurality of embeddings using an attention-based classifier; and generating an output vector to determine that the sample is a malicious script.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 is a system diagram of an architecture for providing malicious script detection using transformer-based deep learning in accordance with some embodiments.

FIG. 2 is a flow diagram for a process for providing malicious script detection using transformer-based deep learning in accordance with some embodiments.

FIG. 3 is another flow diagram for a process for providing malicious script detection using transformer-based deep learning in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls, which can also be implemented using SD-WAN devices).

For example, Palo Alto Networks' next generation firewalls enable enterprises and service providers to identify and control applications, users, and content—not just ports, IP addresses, and packets-using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Malicious Script Detection Using Transformer-Based Deep Learning

Technical and security challenges with malware detection for providing security exist.

Specifically, script related attacks (e.g., script file-based attacks) are a commonly used tool in an attacker's toolkit. As an example, malicious scripts were used in the recent Ukraine Electric Power Grid attack campaign and the APT33 and Oilrig threat groups.

Thus, to provide security solutions to detect such ever evolving script related attacks on the firewall, new and improved security solutions are needed to effectively and efficiently identity script malware.

Generally, many existing security approaches to detect script related malware are primarily pattern-based matching (e.g., through human-defined rules) and/or heuristic-based matching (e.g., heuristic rules). Moreover, some existing security approaches also attempt to utilize various machine learning techniques (MLT) including neural networks (e.g., Convolutional Neural Networks (CNNs)).

However, these existing security approaches can fail to accurately detect the diverse and complex types of script malware attacks that are continually evolving (e.g., changing an API call in a given malware script may avoid malware script detection by such existing security approaches using pattern/heuristic matching approaches and/or neural networking MLT approaches that are based on a pattern and/or a feature, respectively, associated with a predetermined API call for detection of a particular type of malware script). Based on an experiment, such existing approaches over a three week period of testing yielded malicious script detection results that failed to detect 525 of 1252 malicious scripts (e.g., malicious JavaScript (Jscript) files), which corresponds to a very high false negative (FN) rate of approximately 41%.

As such, new and improved techniques are needed to provide an effective and efficient mechanism for malicious script detection.

Accordingly, new and improved techniques for malicious script detection using transformer-based deep learning are disclosed.

In some embodiments, a system/process/computer program product for providing malicious script detection using transformer-based deep learning includes receiving a sample for automated malicious script detection using a computing environment; processing the sample using a transformer model to generate a plurality of embeddings; processing the plurality of embeddings using an attention-based classifier; and generating an output vector to determine that the sample is a malicious script.

In some embodiments, the transformer model includes a plurality of layers in a fully connected layer deep learning neural network, and the transformer model can process inputs of varying lengths. Also, the transformer model can be fine-tuned based on a plurality of distinct malware script types.

In some embodiments, a system/process/computer program product for providing malicious script detection using transformer-based deep learning further includes performing an action in response to determining that the sample is a malicious script.

For example, the transformer model and the attention-based classifier can be included in a binary classification model for malicious script detection, and the binary classification can be configured to perform malicious script detection based at least in part on semantics and contextual information (e.g., which can facilitate detection of malicious script that includes obfuscation and/or other evasive techniques to avoid malicious script detection).

In an example implementation, a transformer-based deep learning (DL) model for script malware detection is disclosed. The transformer-based DL model incorporates a programming language embedding that is trained on a large-sized high-quality corpus (e.g., of malicious and benign script samples, including JavaScript (Jscript) m shell scripts, PowerShell scripts, etc., that can be on the order of billions of samples), facilitating an improved code semantic understanding and representation of the high-level semantics in script files (e.g., which provides a significant improvement in malicious script detection results as compared with prior approaches simply using neural networks, such as CNNs, based on experiment results as described herein).

In this example implementation, the transformer-based DL model is built with an attention-based classifier, which leverages the attention-based neural network's inherent ability to learn from input of varying lengths. As such, this provides for a malicious script detection model that better matches the inherently more variable nature of script programs (e.g., in contrast with, for example, traditional programming languages, such as C, Java, etc., that generally correspond to structured programming languages).

Based on experiments, the transformer-based DL model, such as further described below, achieves a 98.8% true positive rate. In particular, the transformer-based DL model can remove 90% of previous detection false positives (FPs) and can discover 25% previous false negatives (FNs) (conditioned on a 0.05% false positive rate).

The disclosed techniques for providing malicious script detection using transformer-based deep learning provide various technological improvements and advantages over the above-described existing approaches to malicious script detection to facilitate providing a more effective and efficient solution for malicious script detection (e.g., as shown by the experimental results described above).

Code Semantic Understanding Capability: Unlike pattern-based matching approaches that rely on human-defined rules or neural networks for malicious script detection, the disclosed transformer-based DL model incorporates a programming language embedding that is trained on a large-sized, high-quality corpus. This enables the disclosed transformer-based DL model to more effectively understand and represent the high-level semantics of script files, allowing for more accurate detection of malicious scripts in diverse and complex scenarios such as will be further described below.

Input Context Flexibility: The disclosed attention-based classifier used with the disclosed transformer-based DL model can effectively process inputs of varying lengths. This flexibility allows the disclosed transformer-based DL model to more effectively adapt to different types of script files and accommodate the ever-evolving landscape of malicious script attacks such as will be further described below.

Robustness Against Obfuscation: The disclosed transformer-based DL model is more resilient to obfuscation techniques commonly used by attackers to evade detection. As an example, by focusing on high-level semantics and contextual information, the disclosed transformer-based DL model can identify malicious scripts even when they are obfuscated or disguised to appear benign such as will be further described below.

Transfer Learning and Adaptability: The disclosed transformer architecture (e.g., using the disclosed transformer-based DL model) facilitates transfer learning, allowing the transformer-based DL model to be fine-tuned on specific malware types (e.g., specific types of malicious scripts). This adaptability makes it easier to stay ahead of emerging threats and protect against new attack vectors in the ever evolving landscape of malicious script related attacks, such as will be further described below.

These and other embodiments and examples for providing malicious script detection using transformer-based deep learning will be further described below.

### Example System Architectures and Embodiments for Providing Malicious Script Detection Using Transformer-Based Deep Learning

System architectures and embodiments for providing malicious script detection using transformer-based deep learning will now be described.

As similarly discussed above, due to the nature of text structure associated with malicious scripts (e.g., as compared to static analysis of programs written in structured programming languages), the disclosed techniques for providing malicious script detection using transformer-based deep learning facilitate text-based representation learning that can advantageously perform the following: (1) learn semantic meaning of malicious script using improved machine learning techniques as further described below; and (2) utilize the representation's abstraction capability to more effectively process a larger context of malware content for improved malicious script detection as will also be further described below. Based on our experiments, learning from a larger context is important as our recent statistical analysis has revealed that approximately 70% of our malicious script associated malware samples are larger than 1000 bytes in file size.

As such, new and improved techniques for providing malicious script detection using transformer-based deep learning will now be further described below.

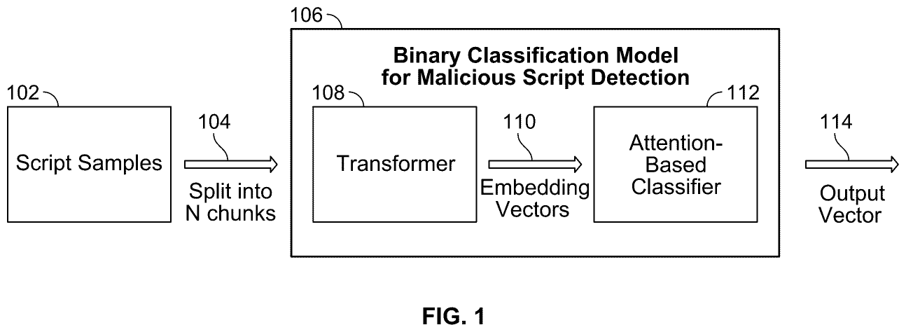

FIG. 1 is a system diagram of an architecture for providing malicious script detection using transformer-based deep learning in accordance with some embodiments.

Referring to FIG. 1, the disclosed architecture for providing malicious script detection using transformer-based deep learning includes a binary classification model for malicious script detection 106 that receives samples (e.g., script samples, including malicious and benign script samples) as shown at 102, which can be split into N chunks, as shown at 104, for processing as input to the binary classification model.

The binary classification model for malicious script detection 106 includes a transformer component 108 (e.g., a pre-trained sentence embedder component). In this example implementation, the transformer component is pre-trained on large numbers of language corpus (e.g., billions of script samples). As shown, the transformer component receives script samples (e.g., script files) split into N chunks and generates embedding vectors 110 (e.g., embedding vector(s), such as for word embeddings, into a high-dimensional space) for each processed script sample. In this example implementation, the disclosed sentence-transformer/sentence-embedder component is implemented using the pre-trained, open source sentence-transformer model known as all-MiniLM-L6-V2 that is publicly available at https://huggingface.co/sentence-transformers/all-MiniLM-L6-v2 (e.g., using 22 million parameters) (e.g., and/or other commercially/publicly available sentence-transformers can similarly be used to perform the disclosed techniques, such as larger-sized models, for example, various open source pre-trained sentenced transformer/sentence-embedder models are publicly available at https://www.sbert.net/docs/sentence_transformer/pretrained_models.html; see also CodeT5 that is publicly available at https://huggingface.co/Salesforce/codet5-large (e.g., 220 million parameters), or all-mpnet-base-v2 that is publicly available at https://huggingface.co/sentence-transformers/all-mpnet-base-v2 (e.g., 100 million parameters)). As would be apparent to one of ordinary skill in the art, selecting among these different sized transformer models is generally a trade-off/balance between compute associated costs and accuracy.

The binary classification model for malicious script detection 106 also includes an attention-based classifier 112 (e.g., a multi-layer perceptron (MLP) attention layer that computes attention weights for sequences of embeddings, such as word embeddings received from the transformer component, in which the output of the last MLP layer serves as the attention weights, such that these attention weights in effect determine the importance of each word embedding in the sequence during the attention layer processing to facilitate generation of the overall/final output vector that provides a prediction as to whether the processed script is potentially malicious or not). In this example implementation, the attention-based classifier component is trained to learn from the embedding sequences (e.g., embedding vectors) and output a verdict for each processed script file (e.g., effectively selecting different embeddings based on the attention score computed using the attention layer processing). The disclosed binary classification model is referred to as a deep learning (DL) model as additional layers (e.g., six or seven layers), including a dense/fully connected (FC) layer, are utilized to facilitate generation of the final/output vector based on the attention layer processing described above. As such, the output can be provided in the form of a vector as shown at 114. The disclosed binary classification model 106 can process and learn from different types of scripts (e.g., JavaScript (Jscript), shell, PowerShell, etc.). In this example implementation, the disclosed attention-based classifier component is implemented using an open source attention-based classifier known as an implementation of the Nyström Self-attention model that is publicly available at https://github.com/lucidrains/nystrom-attention (e.g., and/or other commercially/publicly available attention-based classifier models can similarly be used to perform the disclosed techniques).

Example pseudo code for the above-described attention-based classifier is provided below.

```
def AttentionClassifier(inputEmbeddings):
  positionalEmbedding = learnableParameter( )
  hiddenStates = positionalEmbedding + inputEmbeddings
  hiddenStates = fullyConnectedLayer(hiddenStates)
  for _ in depths:
    hiddenStates = normalizationLayer(hiddenStates)
    hiddenStates = attentionLayer(hiddenStates)
  # dim(logit) == 2 due to binary classification
  logits = fullyConnectedLayer(hiddenStates)
```

For example, the disclosed binary classification model for malicious script detection can be deployed for inline and/or offline malicious script detection, such as in a security cloud service that receives samples for security analysis, and/or executing as a component on an inline security entity (e.g., a container/virtual/hardware implemented NGFW, such as similarly described above, an endpoint security entity, and/or other network entity that can perform inline analysis of files/samples). An action can be performed in response to a verdict that determines that the file (e.g., script sample) is malicious (e.g., the output verdict from a binary classification model for malicious script detection exceeds a predetermined threshold), in which the action can be based on a configured security policy/rule (e.g., block/drop the file/session, log the session, quarantine an endpoint associated with the malicious script, generate an alert, and/or various other actions can similarly be performed based on the configured security policy/rule).

Training and evaluation of the disclosed binary classification model will be further described below.

### Training and Evaluation of the Binary Classification Model

The above-described binary classification model can be trained and evaluated using, for example, script samples (e.g., JScript samples) received from a commercial security services entity (e.g., such as real production JScript samples received from Palo Alto Networks, Inc., headquartered in Santa Clara, CA) and/or other sources of script samples can similarly be utilized for training and evaluation of the binary classification model.

Due to the sheer volume of benign script samples, our evaluation included a randomly selected subset of the benign samples, which included approximately 200,000 files. For malware script samples (e.g., also referred to herein as malicious script samples or malicious scripts), we used all of the available malicious script files.

Based on our experiments using these sets of samples and conditioned on a 0.05% false positive rate (FPR), the disclosed binary classification model for malicious script detection can achieve a 98.8% true positive (TP) rate. In particular, as similarly discussed above based on experiments using the prior pattern/heuristic-based matching and/or neural network approaches, the disclosed binary classification model for malicious script detection can remove 90% of the previous FP detections and discover 25% of the previous FN detections.

In addition, the disclosed binary classification model for malicious script detection can be executed at approximately 100 ms on malicious JScript samples while spent ˜35 ms on benign ones (e.g., executed on commercially available server class hardware, such as using a commercially available cloud computing solution, such as Google Cloud Platform (GCP) or Amazon Web Services (AWS), etc.). For example, we observed that malicious samples often have a relatively large file size (e.g., >1000 bytes), which can generally increase ML model processing overhead.

Moreover, the disclosed techniques for providing malicious script detection using transformer-based deep learning provide various technological improvements and advantages over the above-described existing approaches to malicious script detection to facilitate providing a more effective and efficient solution for malicious script detection (e.g., as shown by the experimental results described above).

Code Semantic Understanding Capability: Unlike pattern-based matching approaches that rely on human-defined rules or neural networks for malicious script detection, the disclosed transformer-based DL model incorporates a programming language embedding that is trained on a large-sized, high-quality corpus as similarly described above. This enables the disclosed transformer-based DL model to more effectively understand and represent the high-level semantics of script files, allowing for more accurate detection of malicious scripts in diverse and complex scenarios. For example, a human-defined rule can miss certain semantics a developer is not familiar with but exists in the malware scripts; or a neural network approach can suffer from overfitting due to its training dataset quality. In contrast, the disclosed techniques that utilize the disclosed embedding layer facilitate superior malicious script detection results, at least in part by providing for an improved capturing of semantics trained from a high quality, large corpus (e.g., a one billion plus sentence based dataset).

Input Context Flexibility: The disclosed attention-based classifier used with the disclosed transformer-based DL model can effectively process inputs of varying lengths. This flexibility allows the disclosed transformer-based DL model to more effectively adapt to different types of script files and accommodate the ever-evolving landscape of malicious script attacks. For example, even within a single type of script file, malware/malicious scripts typically adopt variable or randomized names to obfuscate or evade the pattern-based detection. In contrast, the disclosed techniques that include the disclosed attention-based classifier can effectively accommodate the varying lengths of input for malware/malicious scripts.

Robustness Against Obfuscation: The disclosed transformer-based DL model is more resilient to obfuscation techniques commonly used by attackers to evade detection. As an example, by focusing on high-level semantics and contextual information, the disclosed transformer-based DL model can identify malicious scripts even when they are obfuscated or disguised to appear benign. For example, for the malware/malicious scripts obfuscated based on non-randomization encoding, the disclosed techniques that implement the disclosed deep learning (DL) model can still effectively classify such malware/malicious scripts that have been obfuscated based on non-randomization encoding.

Transfer Learning and Adaptability: The disclosed transformer architecture (e.g., using the disclosed transformer-based DL model) facilitates transfer learning, allowing the transformer-based DL model to be fine-tuned on specific malware types (e.g., specific types of malicious scripts). This adaptability makes it easier to stay ahead of emerging threats and protect against new attack vectors in the ever evolving landscape of malicious script related attacks. Examples of such fine-tuning of the disclosed transformer-based DL model (e.g., implemented using the above-described binary classification model for malicious script detection) includes, for example, performing fine-tuning of the model with a dataset that includes emerging a new family of malware/malicious scripts that use a new type of encoding and were not previously observed (e.g., not previously used in prior training/fine-tuning datasets) to facilitate a continued enhancing of the DL model accuracy for automated detection of malware/malicious scripts as similarly described herein with respect to various embodiments.

As such, the disclosed binary classification model for malicious script detection facilitates a significantly improved security solution for effective and efficient malicious script detection.

Example process embodiments and examples for providing malicious script detection using transformer-based deep learning will be further described below.

### Example Process Embodiments for Providing Malicious Script Detection Using Transformer-Based Deep Learning

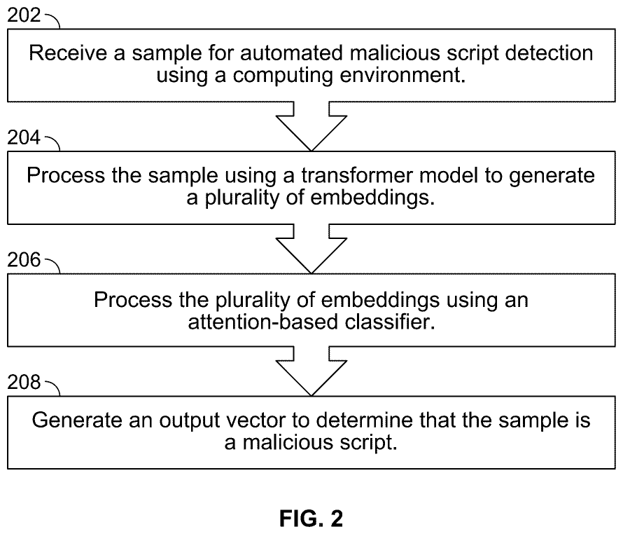

FIG. 2 is a flow diagram for a process for providing malicious script detection using transformer-based deep learning in accordance with some embodiments. In some embodiments, a process as shown in FIG. 2 is performed by the architecture for providing enhanced live virtual machine file system instrumentation for security analysis and techniques as similarly described above including the embodiments described above with respect to FIG. 1.

At 202, a sample is received for automated malicious script detection using a computing environment. For example, the sample can be received at a cloud-based security service (e.g., from an enterprise customer's security platform/firewall/NGFW and/or from an endpoint security entity/agent) for performing automated security analysis using the disclosed techniques (e.g., or such can similarly be performed inline executed on a security entity, such as an enterprise customer's security platform/firewall/NGFW and/or endpoint security entity/agent), such as similarly described above.

At 204, the sample is processed using a transformer model to generate a plurality of embeddings. For example, a sentence-embedding transformer (108) can be implemented as similarly described above with respect to FIG. 1.

At 206, the plurality of embeddings are processed using an attention-based classifier. For example, an attention-based classifier (112) can be implemented as similarly described above with respect to FIG. 1.

At 208, an output vector is automatically generated to determine that the sample is a malicious script. For example, if the output vector exceeds a predetermined threshold, then the sample can be determined to be a malicious script, such as similarly described above with respect to FIG. 1.

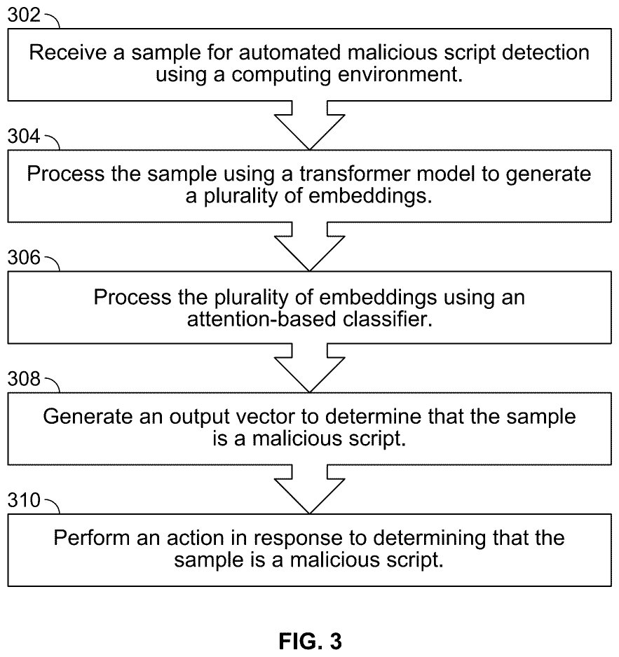

FIG. 3 is another flow diagram for a process for providing malicious script detection using transformer-based deep learning in accordance with some embodiments. In some embodiments, a process as shown in FIG. 3 is performed by the architecture for providing enhanced live virtual machine file system instrumentation for security analysis and techniques as similarly described above including the embodiments described above with respect to FIG. 1.

At 302, a sample is received for automated malicious script detection using a computing environment. For example, the sample can be received at a cloud-based security service (e.g., from an enterprise customer's security platform/firewall/NGFW and/or from an endpoint security entity/agent) for performing automated security analysis using the disclosed techniques (e.g., or such can similarly be performed inline executed on a security entity, such as an enterprise customer's security platform/firewall/NGFW and/or endpoint security entity/agent), such as similarly described above.

At 304, the sample is processed using a transformer model to generate a plurality of embeddings. For example, a sentence-embedding transformer (108) can be implemented as similarly described above with respect to FIG. 1.

At 306, the plurality of embeddings are processed using an attention-based classifier. For example, an attention-based classifier (112) can be implemented as similarly described above with respect to FIG. 1.

At 308, an output vector is automatically generated to determine that the sample is a malicious script. For example, if the output vector exceeds a predetermined threshold, then the sample can be determined to be a malicious script, such as similarly described above with respect to FIG. 1.

At 310, an action is performed in response to determining that the sample is a malicious script. For example, as similarly described above with respect to FIG. 1, the disclosed binary classification model for malicious script detection can be deployed for inline and/or offline malicious script detection, such as in a security cloud service that receives samples for security analysis, and/or executing as a component on an inline security entity (e.g., a container/virtual/hardware implemented NGFW, such as similarly described above, an endpoint security entity, and/or other network entity that can perform inline analysis of files/samples). An action can be performed in response to a verdict that determines that the file (e.g., script sample) is malicious (e.g., the output verdict from a binary classification model for malicious script detection exceeds a predetermined threshold), in which the action can be based on a configured security policy/rule (e.g., block/drop the file/session, log the session, quarantine an endpoint associated with the malicious script, generate an alert, and/or various other actions can similarly be performed based on the configured security policy/rule).

Examples snippets of malicious scripts that can be effectively and efficiently detected using the disclosed techniques for providing malicious script detection using transformer-based deep learning are provided in the Appendix.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a processor configured to:
receive a sample for automated malicious script detection using a computing environment;
process the sample using a transformer model to generate a plurality of embeddings;
process the plurality of embeddings using an attention-based classifier; and
generate an output vector to determine that the sample is a malicious script; and
a memory coupled to the processor and configured to provide the processor with instructions.

2. The system recited in claim 1, wherein the computing environment comprises a virtual machine instance.

3. The system recited in claim 1, wherein the transformer model and the attention-based classifier are included in a binary classification model for malicious script detection.

4. The system recited in claim 1, wherein the transformer model and the attention-based classifier are included in a binary classification model for malicious script detection, and wherein the binary classification model performs the malicious script detection based at least in part on semantics and contextual information.

5. The system recited in claim 1, wherein the transformer model processes inputs of varying lengths.

6. The system recited in claim 1, wherein the transformer model includes a plurality of layers.

7. The system recited in claim 1, wherein the transformer model includes a plurality of layers in a fully connected layer deep learning neural network.

8. The system recited in claim 1, wherein the transformer model is fine-tuned based on a plurality of distinct malware script types.

9. The system recited in claim 1, wherein the determined malicious script includes obfuscation.

10. The system recited in claim 1, wherein the processor is further configured to perform an action in response to determining that the sample is a malicious script.

11. A method, comprising:
receiving a sample for automated malicious script detection using a computing environment;
processing the sample using a transformer model to generate a plurality of embeddings;
processing the plurality of embeddings using an attention-based classifier; and
generating an output vector to determine that the sample is a malicious script.

12. The method of claim 11, wherein the transformer model and the attention-based classifier are included in a binary classification model for malicious script detection.

13. The method of claim 11, wherein the transformer model and the attention-based classifier are included in a binary classification model for malicious script detection, and wherein the binary classification model performs the malicious script detection based at least in part on semantics and contextual information.

14. The method of claim 11, wherein the transformer model includes a plurality of layers.

15. The method of claim 11, wherein the transformer model includes a plurality of layers in a fully connected layer deep learning neural network.

16. The method of claim 11, wherein the transformer model is fine-tuned based on a plurality of distinct malware script types.

17. The method of claim 11, wherein the determined malicious script includes obfuscation.

18. The method of claim 11, further comprising performing an action in response to determining that the sample is a malicious script.

19. A computer program product, the computer program product being embodied in a tangible computer readable storage medium and comprising computer instructions for:
receiving a sample for automated malicious script detection using a computing environment;
processing the sample using a transformer model to generate a plurality of embeddings;
processing the plurality of embeddings using an attention-based classifier; and
generating an output vector to determine that the sample is a malicious script.

20. The computer program product recited in claim 19, further comprising computer instructions for performing an action in response to determining that the sample is a malicious script.
